(19) United States
(12) Patent Application Publication
(10) Pub. No.: US 2007/0205055 A1
(43) Pub. Date: Sep. 6, 2007

(54) Trailerable Miniature Forklift for Moving Portable Toilet Enclosures

(76) Inventor: Daryl Renshaw, Woodruff, SC (US)

Correspondence Address: DORITY & MANNING, P.A., POST OFFICE BOX 1449, GREENVILLE, SC, 29602-1449, US

(21) Appl. No.: 11/674,414

(22) Filed: Feb. 13, 2007

Related U.S. Application Data
(60) Provisional application No. 60/772,764, filed on Feb. 13, 2006.

(51) Int. Cl. B66F 9/06

(52) U.S. Cl. 187/222

(57) ABSTRACT

According to certain aspects of the invention, a trailerable miniature forklift is disclosed for moving portable toilet enclosures. The forklift may include a chassis including a frame, a power source, a control interface, and a plurality of wheels, the chassis sized and configured to permit walk-behind operation of the forklift. The forklift may also include a movable lift arm attached to the chassis configured for selectively lifting or placing a portable toilet enclosure of a given size, the control interface allowing a user to manipulate the power source to drive the forklift chassis via the wheels and to selectively position the movable lift arm relative to the frame. The forklift frame and wheels may be sized and configured so as to define an external perimeter no larger than a portable toilet enclosure of the given size, and the forklift may be sized and configured so as to have a weight that is no more than about four, or three, times the weight of the portable toilet enclosure of the given size. The forklift may if desired be carried on a trailer in substantially unitized registration with a plurality portable toilet enclosures of the given size. The forklift may be rear steerable via a handle. Various options and modifications are possible.

### CROSS REFERENCE TO RELATED APPLICATIONS

The present application claims the benefit under 35 U.S.C. § 119(e) of U.S. Provisional Patent Application No. 60/772,764, filed Feb. 13, 2006, and which is incorporated herein by reference in its entirety.

### FIELD OF THE INVENTION

The present invention relates to a trailerable miniature forklift for moving portable toilet enclosures. The forklift is large and sturdy enough to securely lift and carry portable toilet enclosures, while at the same being compact and lightweight enough to allow the forklift to be readily loaded onto and carried on a truck or trailer. The forklift may be configured to be carriable in substantial registration with a number of portable toilet enclosures on such truck or trailer.

### BACKGROUND OF THE INVENTION

Portable toilet enclosures are somewhat large and heavy items. A typical enclosure has a “footprint” on the order of up to about four feet by four feet, and may be eight feet tall or more. Such a unit may weigh 150-200 pounds when empty and over 400 pounds when full. Such enclosures are typically deployed temporarily, for example at a jobsite or for an event such as a concert. Often, such enclosures are deployed in groups. Typically, a flatbed truck or trailer that can carry mulitple enclosures, at times arranged in two or three column, delivers such enclosures to the desired location.

Once delivered to the location, the enclosures must be removed from the truck or trailer and then placed where desired. This process can be difficult, in particular because of the size, weight, and location of center of gravity of the enclosures, and can be more difficult in some terrains. In the past, dollies have been developed for moving such enclosures by hand. Use of such dollies requires great strength and likely more than one person for secure loading and unloading, in particular where uneven, grassy, or disturbed soil terrain is to be crossed in placing the enclosure, or after use of the enclosures when heavier.

Conventional forklifts have also been used to load, unload and place portable toilet enclosures. However, such forklifts typically weigh well over 1,000 pounds and are larger in “footprint” than the toilet enclosure. Even smaller walk-behind or ride-behind models of conventional forklifts are much larger and heavier than needed for the job. Therefore, if a forklift is to be used rather than a dolly, larger and heavier trucks and trailers need to be used to move the forklift with the enclosures, and/or fewer enclosures can be used with a given truck or trailer due to the size or weight of the forklift. Such issues lead to higher costs and/or reduced efficiency for the owner of enclosures wishing to obtain the benefits of using a forklift rather than a dolly.

### SUMMARY OF THE INVENTION

According to certain aspects of the invention, a trailerable miniature forklift is disclosed for moving portable toilet enclosures, the forklift including a chassis including a frame, a power source, a control interface, and a plurality of wheels, the chassis sized and configured to permit walk-behind operation of the forklift. The forklift may also include a movable lift arm attached to the chassis configured for selectively lifting or placing a portable toilet enclosure of a given size, the control interface allowing a user to manipulate the power source to drive the forklift chassis via the wheels and to selectively position the movable lift arm relative to the frame. The forklift frame and wheels may be sized and configured so as to define an external perimeter no larger than a portable toilet enclosure of the given size, and the forklift may be sized and configured so as to have a weight that is no more than about four times the weight of the portable toilet enclosure of the given size. The forklift may if desired be carried on a trailer in substantially unitized registration with a plurality portable toilet enclosures of the given size. Various options and modifications are possible.

For example, the control interface may be separable from the frame. Also, the lift arm may be detachable from the chassis, and/or may include a base portion, an upright portion attached to the base portion, and retainers extending laterally from opposite sides of the upright portion, the retainers spaced to retain the portable toilet enclosure of the given size therebetween. Also, the power source may include at least one of a hydraulic or pneumatic power source. If desired the chassis may include a lift arm adjustment assembly for selectively lifting and pivoting the lift arm.

The forklift weight may be no greater than about 800 pounds in some configurations, or 500 pounds in others, and the external perimeter may be in the form of a rectangle no larger than about four feet by four feet. The substantially unitized registration may include at least one column, or may include at least two rows and two columns. At least one detachable counterweight may also be provided. The forklift weight be may as little as three times the weight of a portable toilet of the given size.

If desired, the forklift may have front wheels and rear wheels, and the power source may power the front wheels. The rear wheels may be mounted on an axle that is pivotable relative to the chassis around a vertical axis. The control interface may include a handle operationally interconnected to the axle via a steering shaft, the forklift being steerable by turning the rear wheels via the handle. The chassis may have a rear portion of reduced width at each side for reducing a turning radius.

### BRIEF DESCRIPTION OF THE DRAWINGS

FIG. 1 is a side schematic view of a forklift according to certain aspects of the invention.

FIG. 2 is a top schematic view of the forklift of FIG. 1.

FIG. 3 is a schematic view of elements of a control system useful with the forklift if FIG. 1.

FIG. 4 is a side view of a forklift according to certain aspects of the invention loading a toilet enclosure on to a trailer.

FIG. 5 is a rear view of a forklift according to certain aspects of the invention.

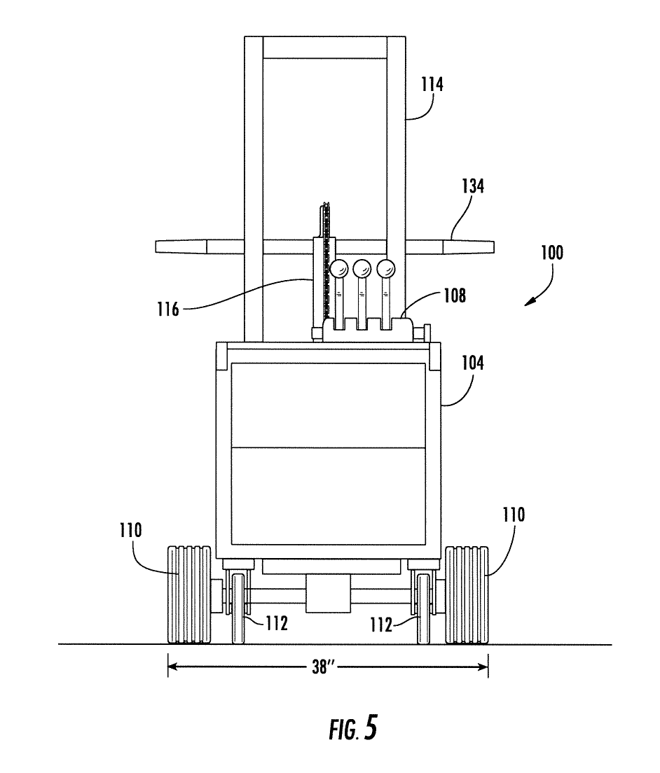

FIG. 6 is a side view of a forklift according to certain aspects of the invention lifting a toilet enclosure, with the lift arm tilted

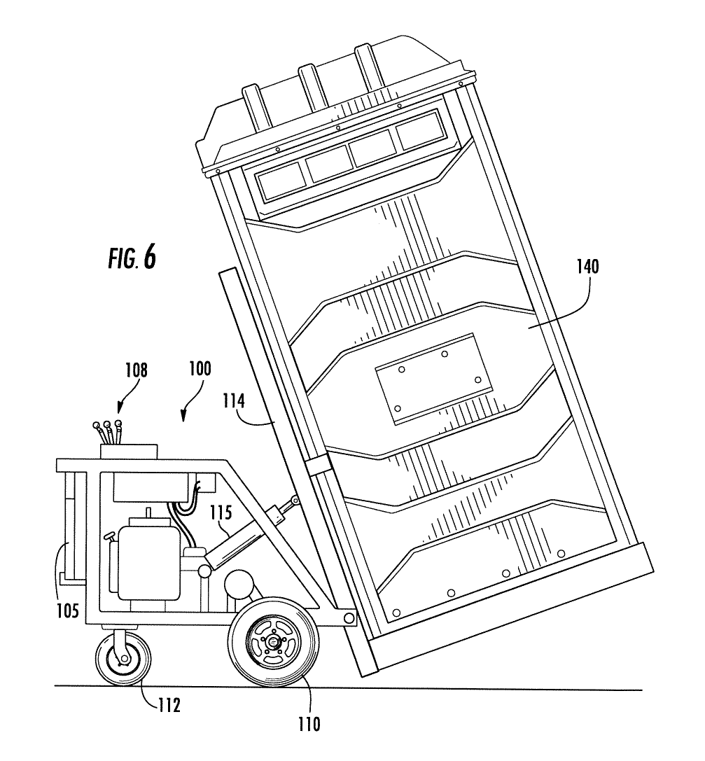

FIG. 7 is a top view of a trailer with a plurality of portable toilet enclosures loaded in four rows and two columns, with a forklift according to certain aspects of the invention in substantial registration.

FIG. 8 is a side view as in FIG. 7.

FIG. 9 is a perspective view of another embodiment of a forklift according to certain aspects of the present invention.

FIG. 10 is a rear view of the embodiment of FIG. 9.

FIG. 11 is a perspective view of the embodiment of FIG. 9, lifting a toilet enclosure.

FIG. 12 is a schematic view of an alternate control system useful with embodiments of the present invention.

### DETAILED DESCRIPTION OF THE INVENTION

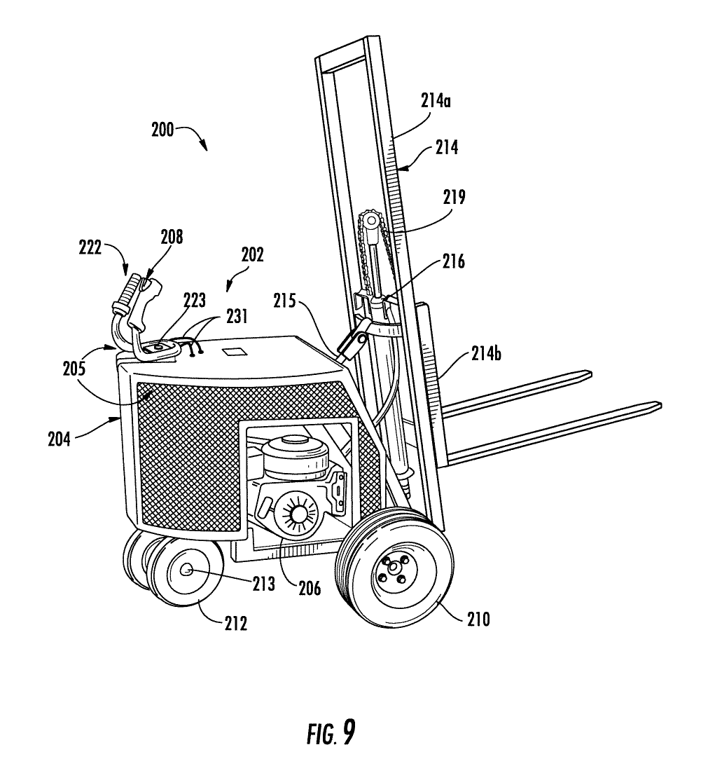

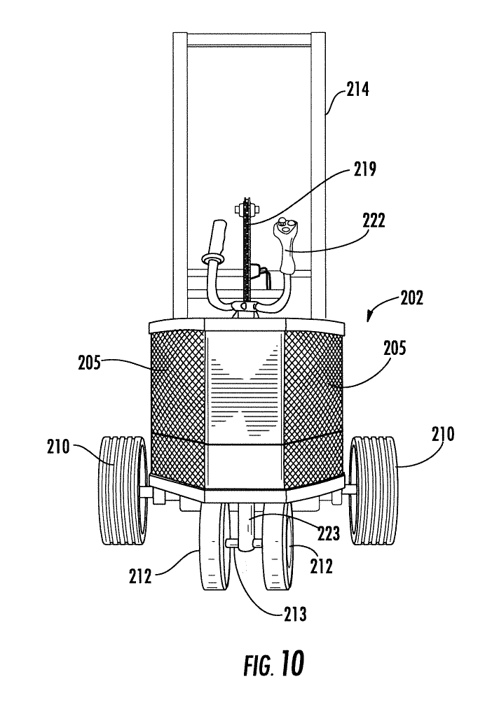

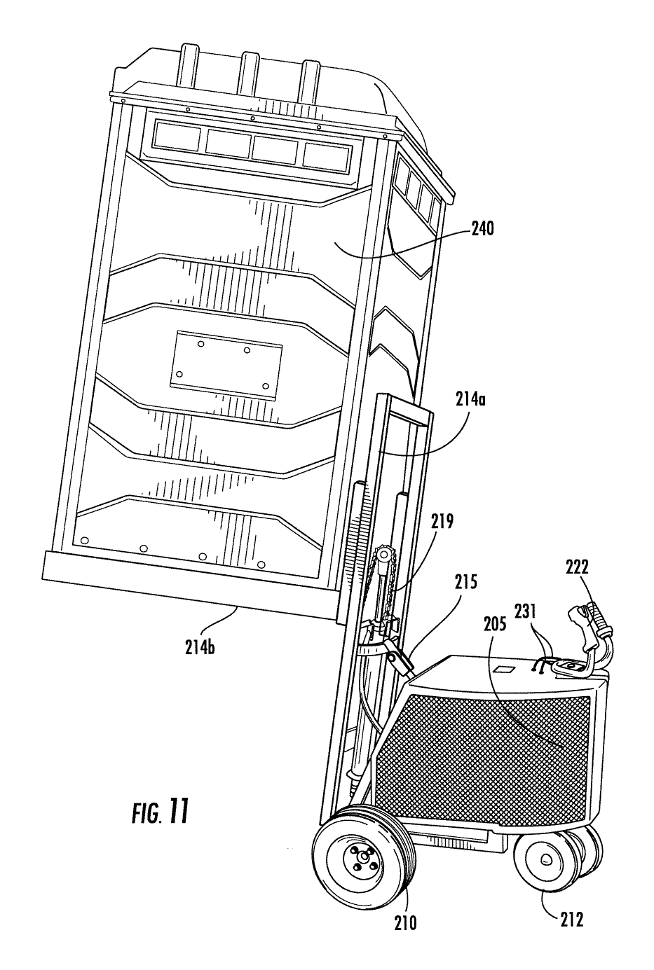

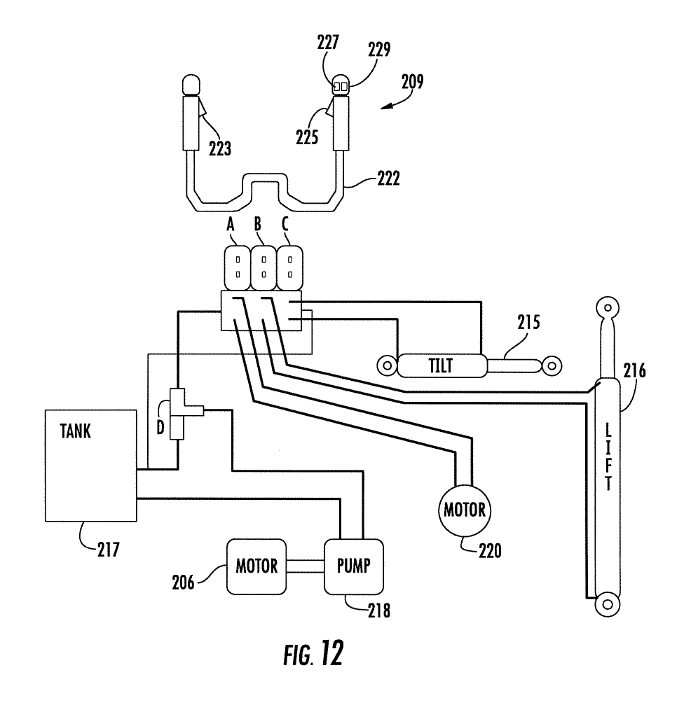

The Figures show various examples of a forklift for use in moving portable toilet enclosures, or other items. As shown, forklift 100 includes a chassis 102 including a frame 104, a power source 106, a control interface 108, front wheels 110, and rear wheels 112. The power source may further comprise a motor 106 and a hydraulic or pneumatic tank 117 and pump 118. A movable lift arm 114 is connected to frame 104 by hydraulic cylinders 115, 116 which allow the lift arm to be raised and lowered as well as tilted through the use of the control system 108. Cylinders 115, 116 may be attached directly to arm 114 and frame 104, or may have ends configured for receiving a chain attached to the arm or frame at locations spaced from the ends of the cylinders (see embodiment of FIGS. 9-12). Back wheels 112 underneath the control interface 108 may swivel to allow for easy maneuverability of the forklift both when bearing a load and when not bearing a load. A person may easily walk behind the forklift controlling the movement of the forklift with the control system.

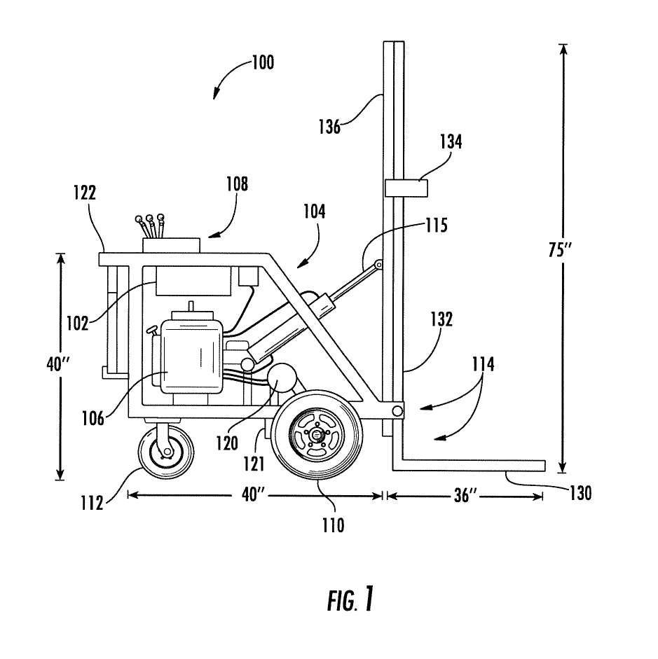

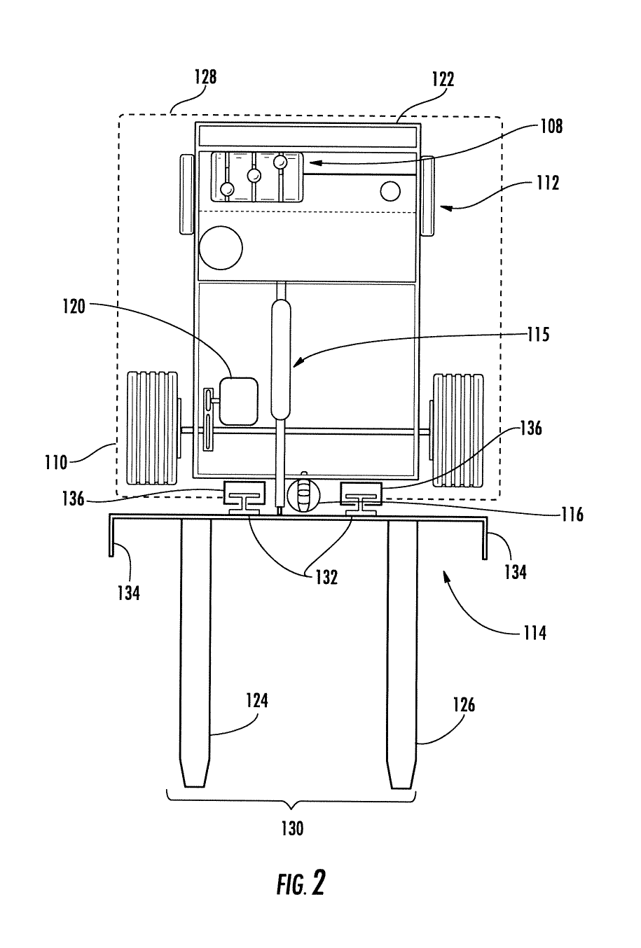

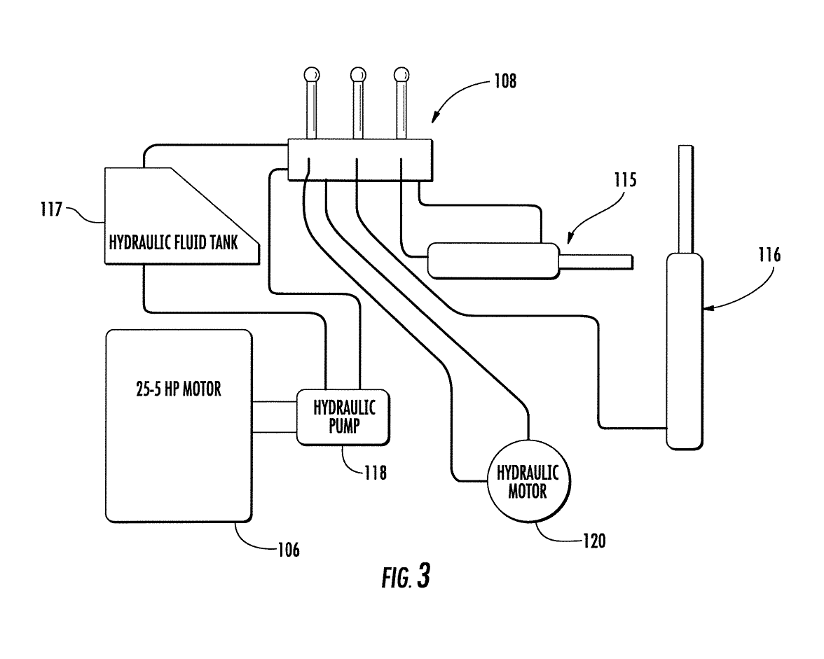

FIG. 2 shows a top view of the forklift and FIG. 3 illustrates elements of the control system for the forklift. As seen in FIG. 2, one hydraulic cylinder 115 controls the horizontal movement for tilting of the lift arm 114 while a second hydraulic cylinder 116 (FIG. 3) controls the vertical displacement of the lift arm. The controls as shown in FIGS. 1, 2 and 3 are connected to hydraulic pump 118 which runs a motor 120 and chain 121 for driving the front wheels 110 of the forklift. Through the use of the control interface 108, the forklift can be moved in a forward and backward direction and the lift arm 104 may be raised, lowered and tilted. A forklift of this construction may include a handle 122 that allows for easy maneuverability by a person standing behind the forklift due to its simple and lightweight construction.

The wheels 110, 112 may permit greater clearance of the forklift than traditional industrial trucks. The front set of wheels 110 may be all terrain tires to help traverse different terrain. The front wheels 110 may be spaced farther apart than the width of frame 104 and forks 124, 126 of the forklift to lower the center of gravity of the forklift as well.

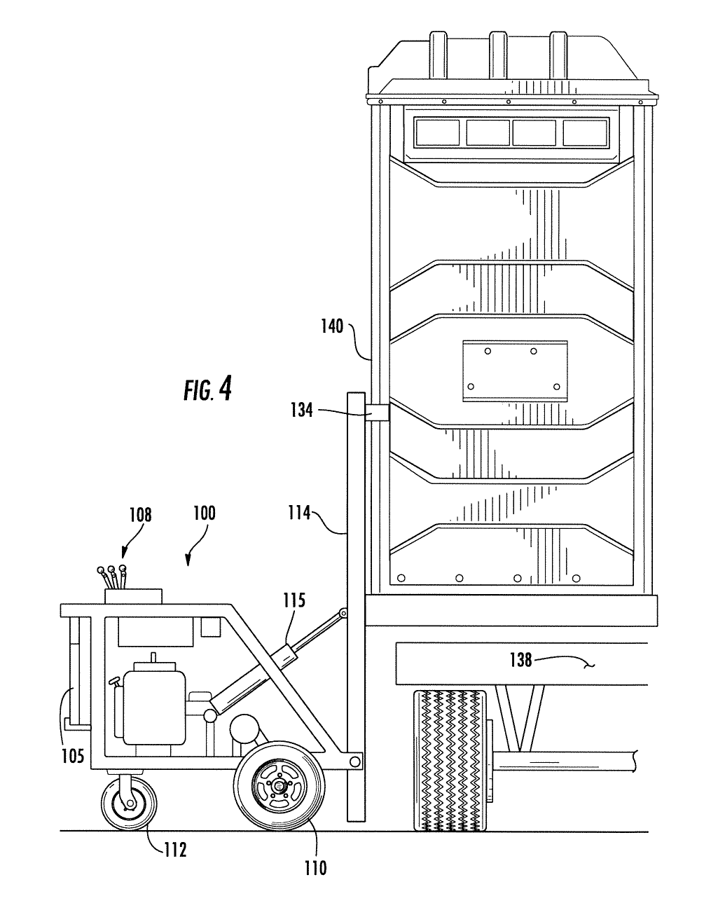

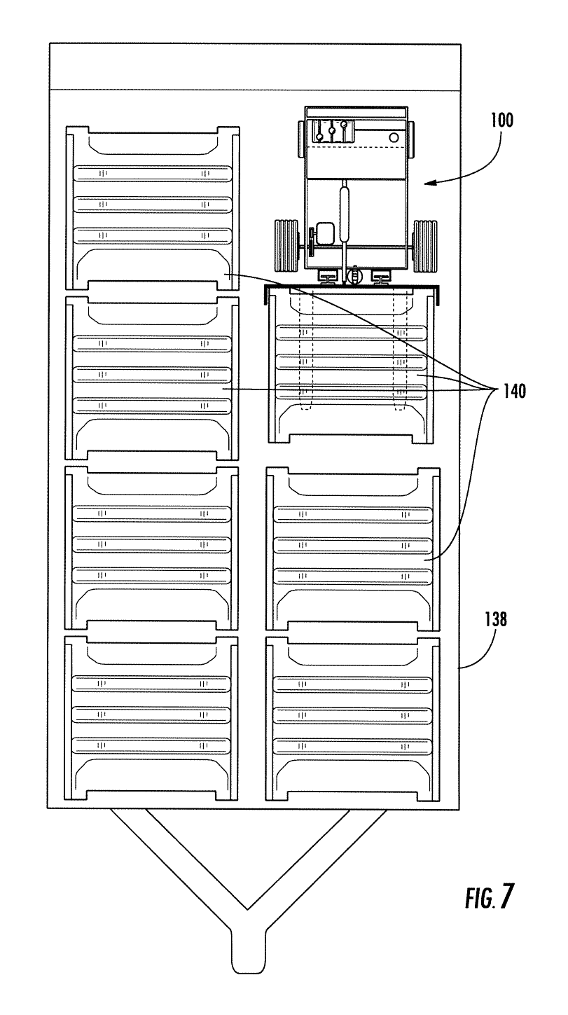

The chassis 102 may be sized and configured to permit walk-behind operation of the forklift. Also, the frame 104 and wheels 110, 112 may be sized and configured so as to define an external perimeter 128 (FIG. 2) no larger than a portable toilet enclosure of a given size. (Note exclusion of forks 124, 126 that may extend beneath an adjacent enclosure, as in FIG. 7). The forklift 100 may also be sized and configured so as to have a weight that is no more than about four times the weight of the portable toilet enclosure of the given size, whereby the forklift may be carried on a trailer in substantially unitized registration with a plurality portable toilet enclosures of the given size. Typically, an enclosure has an external perimeter of no more than four feet square, and a weight of under 200 pounds (when empty). The forklift 100 weight may thus be in the range of no greater than about 800 pounds in some configurations, and less than 500 pounds in others, although this can vary in view of the enclosure weight. If desired, one or more removable counterweights 105 can be provided to help balance the forklift, especially when loaded with a full enclosure. (See FIG. 4, below control interface). Use of a removable counterweight helps keep the weight of the forklift low when the counterweight is not present, yet provides added stability when needed. The forklift 100 external perimeter may be in the form of a rectangle no larger than about four feet by four feet, and this can also vary in view of the enclosure size.

If desired the lift arm 114 may be detachable from the chassis 102. Also, the control interface 108 may be removable from the frame 104 for ease of walk-behind use. The lift arm 114 may include a base portion 130, an upright portion 132 attached to the base portion, and retainers 134 extending laterally from opposite sides of the upright portion. Retainers 134 may be dimensioned and spaced so as to be able to retain portable toilet enclosures of the given size therebetween. Uprights 130 may be provided on forklift 100 as a guide in which upright lift arm portions 132 may be driven in tracks 136 by cylinder 116.

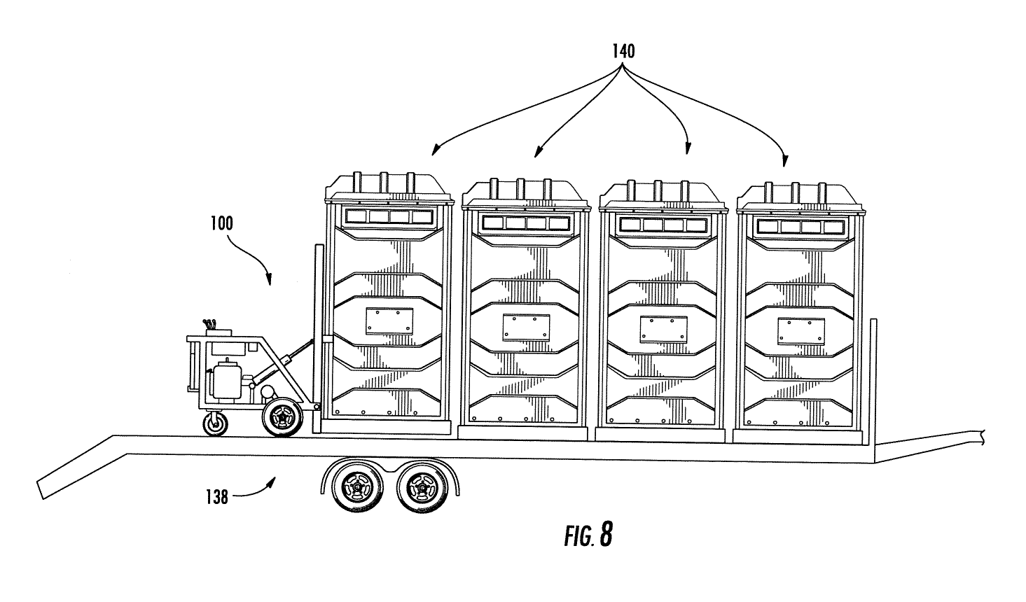

Due to its size, the forklift 100 may be arrangeable on a trailer 138 or truck in substantially unitized registration with one or more rows or columns of toilet enclosures 140, so as to be readily moved to and from a deployment site. (See FIGS. 7 and 8 showing a 4×2 arrangement). The weight of the forklift 100 also allows for easy loading onto the truck or trailer 138. Thus, as compared to previous designs, the disclosed forklift provides the benefits of easy trailering and deployment. It provides some of the benefits of conventional dollies and some of the benefits of conventional forklifts, while avoiding various drawbacks of both.

FIGS. 9-12 show a second embodiment of a forklift according to certain other aspects of the invention. Like numerals will be used to identify like parts with reference to this embodiment. As shown therein, forklift 200 includes a chassis 202 mounted on front and rear wheels 210 and 212, respectively. Forklift 200 also includes a frame 204, a power source 206, a control interface 208 mounted to a handle 222, and a lift arm 214. The handle 222 is pivotally mounted via a steering shaft 223 so as to be able to pivot axle 213 of rear wheels 212 about a vertical axis extending though shaft 223, thereby providing a rear steer capability. Rear portion 205 of chassis 202 is tapered inward on both sides to allow for a smaller turning radius for forklift 200.

Power source may comprise, for example, an engine 206 such as a 5.5 horsepower engine, mounted to frame 204, for driving a system such as a hydraulic tank 217 and pump 218, such as a 1.5 gpm pump. Tank 217 may have a volume of 6-8 gallons, although larger or smaller tanks may be employed depending on the desired size of the device. Smaller tanks have the advantage of less weight, but may require use of a counterweight when lifting enclosures.

Lift cylinder 216 may be a 2.5×24 inch cylinder, whereas tilt cylinder 215 may be a 2×8 inch cylinder. Again, other sizes may be employed as desired for a particular application. If desired, a chain 219 may be employed, attached at one end to a pivotable portion 214a of lift arm 214 and at the other end to a slidable portion 214b of lift arm 214, to effectively double the output of lift cylinder 216.

Valving and controls of various designs may be employed to control forklift 200 and its components. As shown, three valves A, B, and C are connected to the hydraulic system and control interface 208. Valve A controls motor 220 for wheels 210. Valve B controls lift cylinder 216. Valve C controls tilt cylinder 215. Valve A is a proportional directional valve, rated 12V. Valves B and C are closed directional valves, rated 12V. Valve D is a normally open 12V flow control valve connected to pump 218 and tank 217.

Controls may be mounted to handle 222 to control some or all of Valves A-D, and/or other components of forklift 200. If desired forward and reverse 223, 225 trigger switches may be used to control motor 220. These may be proportional 0-12V switches. Alternatively, the triggers may be replaced with a single slide switch. Also, toggle switches 227 and 229 may be used to control the lift and tilt cylinders 115, 116. These may be 12V switches. Wiring 231 may connect the controls to the valves or other controls components. Of course other types of switches and controls could be employed.

It should be understood that the foregoing description provides only exemplary embodiments and discussion of examples of the invention. Various modifications and options are possible. For example, lift arm 214 does not include retainers, such as retainers 134 above. It should be understood that such retainers are optional depending on the application. Also, the hydraulic system, motors, controls, and switches could be replaced or modified in function and orientation. Further the shape of the chassis and lift arm are also modifiable to meet particular applications. Accordingly, set forth below are claims covering certain aspects of the invention; however, a full scope of the invention is to be ascertained from the claims, their equivalents, and the full contents of this application.

1. A trailerable miniature forklift for moving portable toilet enclosures, the forklift comprising:
a chassis including a frame, a power source, a control interface, and a plurality of wheels, the chassis sized and configured to permit walk-behind operation of the forklift; and
a movable lift arm attached to the chassis configured for selectively lifting or placing a portable toilet enclosure of a given size, the control interface allowing a user to manipulate the power source to drive the forklift chassis via the wheels and to selectively position the movable lift arm relative to the frame;
the forklift frame and wheels being sized and configured so as to define an external perimeter no larger than a portable toilet enclosure of the given size, and the forklift being sized and configured so as to have a weight that is no more than about four times the weight of the portable toilet enclosure of the given size, whereby the forklift may be carried on a trailer in substantially unitized registration with a plurality portable toilet enclosures of the given size.

2. The forklift of claim 1, wherein the control interface is separable from the frame.

3. The forklift of claim 1, wherein the lift arm includes a base portion and an upright portion attached to the base portion.

4. The forklift of claim 3, wherein the lift arm includes retainers extending laterally from opposite sides of the upright portion, the retainers spaced to retain the portable toilet enclosure of the given size therebetween.

5. The forklift of claim 1, wherein the power source includes at least one of a hydraulic or pneumatic power source.

6. The forklift of claim 1, wherein the chassis includes a lift arm adjustment assembly for selectively lifting and pivoting the lift arm.

7. The forklift of claim 1, wherein the forklift weight is no greater than about 800 pounds.

8. The forklift of claim 1, wherein the external perimeter is in the form of a rectangle no larger than about four feet by four feet.

9. The forklift of claim 1, wherein the substantially unitized registration includes at least one column.

10. The forklift of claim 1, wherein the substantially unitized registration includes at least two rows and two columns.

11. The forklift of claim 1, wherein the lift arm is detachable from the chassis.

12. The forklift of claim 1, further including at least one detachable counterweight.

13. The forklift of claim 1, wherein a plurality of wheels includes front wheels and rear wheels, and the power source powers the front wheels.

14. The forklift of claim 13, wherein the rear wheels are mounted on an axle that is pivotable relative to the chassis around a vertical axis.

15. The forklift of claim 14, wherein the control interface includes a handle operationally interconnected to the axle via a steering shaft, the forklift being steerable by turning the rear wheels via the handle.

16. The forklift of claim 15, wherein the chassis has a rear portion of reduced width at each side for reducing a turning radius.

17. The forklift of claim 1, wherein the forklift is sized and configured so as to have a weight that is no more than about three times the weight of the portable toilet enclosure of the given size.
